(19) United States
(12) Patent Application Publication
(10) Pub. No.: US 2021/0054125 A1
(43) Pub. Date: Feb. 25, 2021

(54) METHOD FOR PRODUCING AN OBJECT FROM A PRECURSOR, AND USE OF A RADICALLY CROSS-LINKABLE RESIN IN AN ADDITIVE PRODUCTION METHOD

(71) Applicant: Covestro Deutschland AG, Leverkusen (DE)

(72) Inventors: Dirk Achten, Leverkusen (DE); Thomas BÜSGEN, Leverkusen (DE); Florian GOLLING, Düsseldorf (DE); Roland WAGNER, Leverkusen (DE); Christoph TOMCZYK, Leverkusen (DE); Jörge TILLACK, Solingen (DE); Christoph EGGERT, Köln (DE); Hans-Josef LAAS, Odenthal (DE); Florian STEMPFLE, Köln (DE)

(21) Appl. No.: 16/463,627

(22) PCT Filed: Dec. 4, 2017
(86) PCT No.: PCT/EP2017/081365

§ 371 Date: May 23, 2019

(30) Foreign Application Priority Data
Dec. 5, 2016 (EP) 16202219.8

(51) Int. Cl. C08F 220/34; B29C 64/124; B33Y 10/00; B33Y 70/00

(52) U.S. Cl. CPC C08F 220/343; B29C 64/124; B29K 2105/0002; B33Y 70/00; B33Y 10/00

(57) ABSTRACT

The invention relates to a method for producing an object from a precursor, comprising the steps: I) depositing a radically cross-linked resin on a carrier so that a layer of a construction material connected to the carrier is obtained, said layer corresponding to a first selected cross-section of the precursor; II) depositing a radically cross-linked resin on a previously applied layer of the construction material so that an additional layer of the construction material is obtained, which corresponds to a further selected cross-section of the precursor and which is connected to the previously applied layer; III) repeating step II) until the precursor is formed, wherein, at least in step II), the deposition of a radically cross-linked resin is carried out by allowing energy to act on a selected region of a radically cross-linkable resin, corresponding to the respectively selected cross-section of the object, wherein the radically cross-linkable resin has a viscosity (23° C., DIN EN ISO 2884-1) of =5 mPas to =100000 mPas. The radically cross-linkable resin comprises a curable component, in which NCO groups which are blocked with a blocking agent, compounds having at least two Zerewitinoff-active H atoms and olefinic C═C double bonds are present, wherein the blocking agent is an isocyanate or the blocking agent is selected in such a manner that, after deblocking of the NCO group, no release of the blocking agent as a free molecule or as a part of other molecules or molecule parts occurs. Following step III), step IV) is carried out: IV) treating the precursor obtained according to step III) under conditions which are sufficient to at least partially deblock NCO groups which are present in the radically cross-linked resin of the obtained precursor, and to react the resulting functional groups with compounds having at least two Zerewitinoff-active H atoms, with the result that the object is obtained.

The present invention relates to a process for producing an object from a precursor, comprising the steps of:
I) depositing a free-radically crosslinked resin atop a carrier to obtain a ply of a construction material joined to the carrier which corresponds to a first selected cross section of the precursor,
II) depositing a free-radically crosslinked resin atop a previously applied ply of the construction material to obtain a further ply of the construction material which corresponds to a further selected cross section of the precursor and which is joined to the previously applied ply;
III) repeating step II) until the precursor is formed;
   wherein the depositing of a free-radically crosslinked resin at least in step II) is effected by introducing energy to a selected region of a free-radically crosslinkable resin corresponding to the respectively selected cross section of the object, and wherein the free-radically crosslinkable resin has a viscosity (23° C., DIN EN ISO 2884-1) of ≥5 mPas to ≤100 000 mPas.

The invention further relates to the use of a free-radically crosslinkable resin having a viscosity (23° C., DIN EN ISO 2884-1) of ≥5 mPas to ≤100 000 mPas in an additive manufacturing process and to a polymer obtainable from the crosslinking of such a resin.

The blocking of polyisocyanates for temporary protection of the isocyanate groups is a method of working which has long been known and is described for example in Houben-Weyl, Methoden der organischen Chemie XIV/2, pp. 61-70. This also includes polyisocyanates containing uretdione groups in which two of the isocyanate groups are in latent form.

US 2015/072293 A1 discloses an additive manufacturing process using a photopolymer in which photo-curable polyurethane compositions are considered particularly suitable materials. Such compositions contain a polyurethane based on an aliphatic diisocyanate, poly(hexamethylene isophthalate glycol) and optionally 1,4-butanediol and also a polyfunctional acrylic ester, a photoinitiator and an antioxidant (U.S. Pat. No. 4,337,130). Photo-curable thermoplastic polyurethane elastomers may contain photo-reactive diacetylene diols as chain extenders.

US 2016/136889 A1 and US 2016/137838 A1 likewise relate to additive manufacturing processes using a photopolymer. Polymerizable liquids curable via a two-stage mechanism and containing blocked functional groups and thermally cleavable blocking groups may be employed. Present in some embodiments is a reactive blocked prepolymer obtainable by reaction of a diisocyanate with an amino (meth)acrylate monomer blocking reagent such as tert-butylaminoethyl methacrylate (TBAEMA), tert-pentylaminoethyl methacrylate (TPAEMA), tert-hexylaminoethyl methacrylate (THAEMA), tert-butylaminopropyl methacrylate (TBAPMA), acrylate analogs thereof or mixtures thereof (US 2013/0202392 A1). It is intimated that during a thermal curing the blocking agent is cleaved to reobtain the diisocyanate prepolymer. This reacts rapidly with chain extenders or further soft segments to form a thermoplastic or thermosetting polyurethane, polyurea or copolymer thereof. The UV-curable (meth)acrylate-blocked polyurethane is referred to as “ABPU” in these publications.

The disadvantage of such blocking agents removable by cleavage is that they may be liberated as volatile organic compounds (VOCs) or, as in the case of ABPU, while being incorporated into a polymer network by polymerization, limit the freedom of choice of materials for the additive manufacturing process on account of this boundary condition.

It is an object of the present invention to at least partially overcome at least one disadvantage of the prior art. It is a further object of the invention to provide an additive manufacturing process where the produced objects can exhibit a high resolution coupled with a high strength without volatile organic compounds being liberated. Finally, it is an object of the invention to be able to produce such objects in a manner which is as cost-efficient and/or individualized and/or resource-sparing as possible.

The object is achieved in accordance with the invention by a process as claimed in claim 1 and a use as claimed in claim 13. A polymer thus obtainable forms the subject matter of claim 15. Advantageous developments are specified in the subsidiary claims. They may be combined as desired, unless the opposite is apparent from the context.

A process according to the invention for producing an object from a precursor comprises the steps of:
I) depositing a free-radically crosslinked resin atop a carrier to obtain a ply of a construction material joined to the carrier which corresponds to a first selected cross section of the precursor,
II) depositing a free-radically crosslinked resin atop a previously applied ply of the construction material to obtain a further ply of the construction material which corresponds to a further selected cross section of the precursor and which is joined to the previously applied ply,
III) repeating step II) until the precursor is formed;
   wherein the depositing of a free-radically crosslinked resin at least in step II) is effected by introducing energy to a selected region of a free-radically crosslinkable resin corresponding to the respectively selected cross section of the object, and wherein the free-radically crosslinkable resin has a viscosity (23° C., DIN EN ISO 2884-1) of ≥5 mPas to ≤100 000 mPas.

The free-radically crosslinkable resin comprises a curable component comprising NCO groups blocked with a blocking agent, compounds having at least two Zerewitinoff-active H atoms and olefinic C═C double bonds, wherein the blocking agent is an isocyanate or the blocking agent is selected such that deblocking of the NCO group is not followed by liberation of the blocking agent as a free molecule or as a part of other molecules or moieties.

In the process according to the invention step III) is followed by a farther step IV):
IV) treating the precursor obtained after step III) under conditions sufficient for at least partially deblocking NCO groups present in the free-radically crosslinked resin of the obtained precursor and reacting the thus obtained functional groups with compounds having at least two Zerewitinoff-active H atoms to obtain the object.

In the process according to the invention the object is thus obtained in two production phases. The first production phase may be regarded as a construction phase. This construction phase may be realized by means of ray-optic additive manufacturing processes such as stereolithography or the DLP (digital light processing) process or else by inkjet printing processes combined with radiative crosslinking and forms the subject matter of the steps I), II) und III). The second production phase may be regarded as a curing phase and forms the subject matter of step IV). Here, the precursor or intermediate object obtained after the construction phase is converted into a more mechanically durable object, without further changing the shape thereof. In the context of the present invention the material from which the precursor is obtained in the additive manufacturing process is referred to generally as “construction material”.

Step I) of the process comprises depositing a free-radically crosslinked resin atop a carrier. This is usually the first step in stereolithography and DLP processes. In this way a ply of a construction material joined to the carrier which corresponds to a first selected cross section of the precursor is obtained.

As per the instruction of step II), step II) is repeated until the desired precursor is formed. Step II) comprises depositing a free-radically crosslinked resin atop a previously applied ply of the construction material to obtain a further ply of the construction material which corresponds to a further selected cross section of the precursor and which is joined to the previously applied ply. The previously applied ply of the construction material may be the first ply from step I) or a ply from a previous run of step II).

It is provided in accordance with the invention that the depositing of a free-radically crosslinked resin at least in step II) (preferably also in step I) is effected by exposure and/or irradiation of a selected region of a free-radically crosslinkable resin corresponding to the respectively selected cross section of the object. In the context of the present invention the terms “free-radically crosslinkable resin” and “free-radically crosslinked resin” are used. The free-radically crosslinkable resin is converted here into the free-radically crosslinked resin by the exposure and/or irradiation which triggers free-radical crosslinking reactions. “Exposure” is to be understood in the present context as meaning introduction of light in the range between near-IR and near-UV light (wavelengths of 1400 nm to 315 nm). The remaining shorter wavelength ranges are covered by the term “irradiation”, for example far UV light, x-ray radiation, gamma radiation and also electron radiation.

The selecting of the respective cross section is advantageously effected by means of a CAD program, with which a model of the object to be produced has been generated. This operation is also known as “slicing” and serves as a basis for controlling the exposure and/or irradiation of the free-radically crosslinkable resin.

The free-radically crosslinkable resin has a viscosity (23° C., DIN EN ISO 2884-1) of ≥5 mPas to ≤100 000 mPas. It may accordingly be regarded as a liquid resin at least for the purposes of additive manufacture. The viscosity is preferably ≥50 mPas to ≤20 000 mPas, more preferably 2 200 mPas to 5 5000 mPas.

In the process the free-radically crosslinkable resin further comprises a curable component comprising NCO groups blocked with a blocking agent, compounds having at least two Zerewitinoff-active H atoms and olefinic C═C double bonds, wherein the blocking agent is an isocyanate or the blocking agent is selected such that deblocking of the NCO group is not followed by liberation of the blocking agent as a free molecule or as a part of other molecules or moieties.

In addition to the curable component the free-radically crosslinkable resin may also comprise a non-curable component in which for example stabilizers, fillers and the like are encompassed. In the curable component the blocked NCO groups and the olefinic C═C double bonds may be present in separate molecules and/or in a common molecule. When blocked NCO groups and olefinic C═C double bonds are present in separate molecules the body obtained after step IV) of the process according to the invention may exhibit an interpenetrating polymer network.

In the process step III) is further followed by step IV). This step comprises treating the precursor obtained after step III) under conditions sufficient for at least partially deblocking NCO groups present in the free-radically crosslinked resin of the obtained precursor and reacting the thus obtained functional groups with compounds having at least two Zerewitinoff-active H atoms to obtain the object. A deblocking of the NCO groups in the context of the present invention therefore need not necessarily mean that an NCO group is reobtained. On the contrary, this may also mean that deblocking may afford a functional group such as an acyl cation group which reacts to form a covalent bond with other functional groups having Zerewitinoff-active H atoms.

It is preferable when the reaction is performed until ≤50%, preferably ≤30% and more preferably ≤20% of the blocked isocyanate groups originally present in the curable component remain present. This may be determined by surface IR spectroscopy. It is further preferable when in step IV) ≥50%, ≥60%, ≥70% or ≥2 80% of the NCO groups deblocked in the curable component react with the compound having at least two Zerewitinoff-active H atoms.

It is preferable when step IV) is performed only when the entirety of the construction material of the precursor has reached its gel point. The gel point is regarded as reached when in a dynamic mechanical analysis (DMA) with a plate/plate oscillation viscometer in accordance with ISO 6721-10 at 20° C. the graphs of the storage modulus G′ and the loss modulus G″ intersect. The precursor is optionally subjected to further exposure and/or radiation to complete free-radical crosslinking. The free-radically crosslinked resin can exhibit a storage modulus G′ (DMA, plate/plate oscillation viscometer according to ISO 6721-10 at 20° C. and a shear rate of 1/s) of ≥10⁶ Pa.

The free-radically crosslinkable resin may further contain additives such as fillers, UV-stabilizers, free-radical inhibitors, antioxidants, mold release agents, water scavengers, slip additives, defoamers, flow agents, rheology additives, flame retardants and/or pigments. These auxiliaries and additives, excluding fillers and flame retardants, are typically present in an amount of less than 10 wt %, preferably less than 5 wt %, particularly preferably up to 3 wt %, based on the free-radically crosslinkable resin. Flame retardants are typically present in amounts of not more than 70 wt %, preferably not more than 50 wt %, particularly preferably not more than 30 wt %, calculated as the total amount of employed flame retardants based on the total weight of the free-radically crosslinkable resin.

Suitable fillers are for example carbon black, silica, AlOH₃, CaCO₃, metal pigments such as TiO₂ and further known customary fillers. These fillers are preferably employed in amounts of not more than 70 wt %, preferably not more than 50 wt %, particularly preferably not more than 30 wt %, calculated as the total amount of employed fillers based on the total weight of the free-radically crosslinkable resin.

Suitable UV stabilizers may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or 2,2′-dihydroxy-4-dodecyloxybenzophenone; benzotriazole derivatives, for example 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(l-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides, for example 2-ethyl-2′-ethoxy- or 4-methyl-4′-methoxyoxalanilide; salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred light stabilizers may be used either individually or in any desired combinations with one another.

Particularly preferred UV stabilizers are those which absorb a large proportion of radiation having a wavelength<400 nm. These include the recited benzotriazole derivatives for example. Very particularly preferred UV stabilizers are 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol and/or 2-(5-chloro-2H-benzotriazol-2-yl)-4,6-bis(1,1-dimethylethyl)phenol.

One or more of the UV stabilizers recited by way of example are optionally added to the free-radically crosslinkable resin preferably in amounts of 0.001 to 3.0 wt %, particularly preferably 0.005 to 2 wt %, calculated as the total amount of employed UV stabilizers based on the total weight of the free-radically crosslinkable resin.

Suitable antioxidants are preferably sterically hindered phenols which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used either individually or in any desired combinations with one another as required.

These antioxidants are preferably employed in amounts of 0.01 to 3.0 wt %, particularly preferably 0.02 to 2.0 wt %, calculated as the total amount of employed antioxidants based on the total weight of the free-radically crosslinkable resin.

Embodiments and further aspects of the present invention are elucidated hereinbelow. These may be combined with one another as desired unless the opposite is apparent from the context.

In a preferred embodiment the blocking agent is selected from the group consisting of organic isocyanates, lactams, glycerol carbonate, a compound of general formula (I):

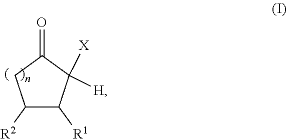

in which X is an electron-withdrawing group, R¹ and R² independently of one another represent the radicals H, C₁-C₂₀-(cyclo)alkyl, C₆-C₂₄-aryl, C₁-C₂₀-(cyclo)alkyl ester or -amide, C₆-C₂₄-aryl ester or amide, mixed aliphatic/aromatic radicals having 1 to 24 carbon atoms which may also be part of a 4 to 8-membered ring and n is an integer from 0 to 5
or a combination of at least two of these.

The electron-withdrawing group X may be selected from any substituents which result in CH-acidity of the α-hydrogen. These may include for example ester groups, amide groups, sulfoxide groups, sulfone groups, nitro groups, phosphonate groups, nitrile groups, isonitrile groups, polyhaloalkyl groups, halogens such as fluorine, chlorine or carbonyl groups. Nitrile and ester groups are preferred and methyl carboxylate and ethyl carboxylate groups are particularly preferred. Also suitable are compounds of general formula (I) whose ring optionally contains heteroatoms, such as oxygen, sulfur or nitrogen atoms. It is preferable when the activated cyclic ketone of formula (I) has a ring size of 5 (n=1) and 6 (n=2).

Preferred compounds of general formula (I) are cyclopentanone-2-carboxymethyl ester and -carboxyethyl ester, cyclopentanone-2-carbonitrile, cyclohexanone-2-carboxymethyl ester and -carboxyethyl ester or cyclopentanone-2-carbonylmethyl. Cyclopentanone-2-carboxymethyl ester and -carboxyethyl ester and also cyclohexanone-2-carboxymethyl ester and -carboxyethyl ester are particularly preferred. The cyclopentanone systems are industrially readily obtainable by a Dieckmann condensation of dimethyl adipate or diethyl adipate. Cyclohexanone-2-carboxymethyl ester may be produced by hydrogenation of methyl salicylate.

In the case of compounds of type (1) the blocking of the NCO groups, the deblocking and the reaction with polyols or polyamines proceed according to the following exemplary scheme:

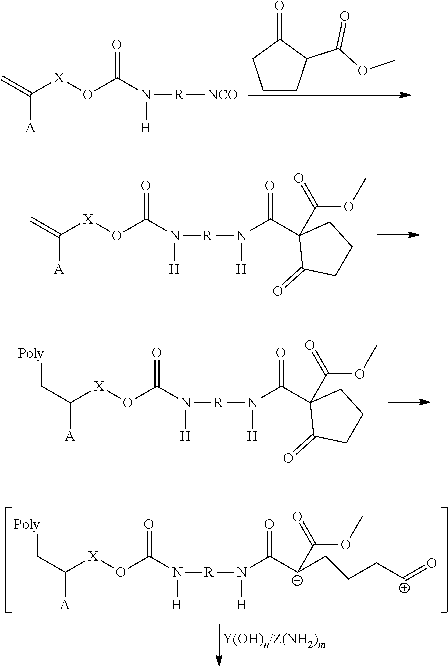

A represents any desired radical, preferably hydrogen or alkyl. The group X joins the alkenyl portion of the molecule with the remainder of the molecule and is in particular a carbonyl group. The group R represents any desired further radical. For example the starting molecule for the above scheme may be understood to mean the addition product of one molecule of hydroxyalkyl (meth)acrylate such as 2-hydroxyalkyl methacrylate (HEMA) onto a diisocyanate or a difunctional NCO-terminated prepolymer to form a urethane group. The β-diketone of general formula (I) in which R¹ and R² represent H and X represents C(O)OCH₃ undergoes addition via its C—H-acidic C atom onto the free NCO-group to form a further urethane group. In this way a free-radically polymerizable molecule having a blocked NCO group is obtained. The free-radical polymerization of the C═C double bonds results in the formation of a polymer whose chain was referred to schematically as “poly” in the above scheme. The NCO group may subsequently be deblocked again. This is achieved by opening the cyclopentanone ring, thus formally forming a carbanion and an acyl cation. This is represented by the intermediate shown in square brackets. A polyol Y(OH)ₙ or a polyamine Z(NH₂)ₘ (secondary amines are of course also possible) where n≥2 and m≥2 undergo formal addition onto the acyl cation with their OH group or amino group, an H atom further migrating to the carbanion C atom. As is readily apparent the blocking agent remains covalently bonded in the polymer molecule.

The blocking of NCO groups, deblocking thereof and the reaction of the functional groups obtained after the deblocking with polyols or polyamines based on glycerol carbonate is shown by way of example in the following scheme:

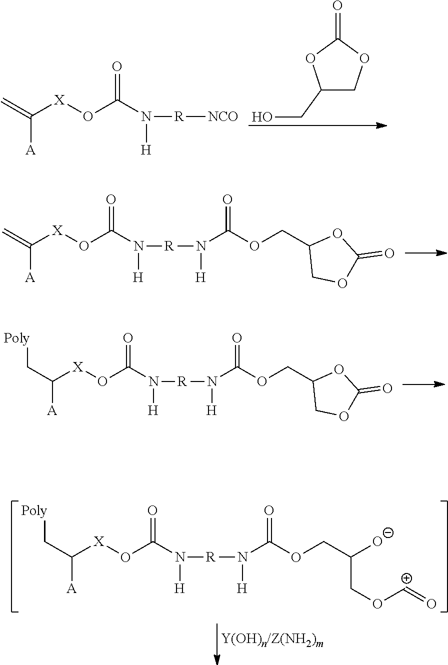

Here too, A represents any desired radical, preferably hydrogen or alkyl. The group X joins the alkenyl portion of the molecule with the remainder of the molecule and is in particular a carbonyl group. The group R represents any desired further radical. For example the starting molecule for the above scheme may be understood to mean the addition product of one molecule of hydroxyalkyl (meth)acrylate such as 2-hydroxyalkyl methacrylate (HEMA) onto a diisocyanate or a difunctional NCO-terminated prepolymer to form a urethane group. The glycerol carbonate undergoes addition via its free OH group onto the free NCO group to form a further urethane group. In this way a free-radically polymerizable molecule having a blocked NCO group is obtained. The free-radical polymerization of the C═C double bonds results in the formation of a polymer whose chain was referred to schematically as “poly” in the above scheme. The NCO group may subsequently be deblocked again. This is achieved by opening the cyclic carbonate ring, thus formally forming an alkoxide ion and an acyl cation. This is represented by the intermediate shown in square brackets. An alcohol Y(OH)ₙ or an amine Z(NH₂)ₘ (secondary amines are of course also possible) where n≥2 and m≥2 undergo formal addition onto the acyl cation with their OH group or amino group, a proton further migrating to the carbanion C atom. As is readily apparent the blocking agent remains covalently bonded in the polymer molecule.

In the case of lactams ε-caprolactam is preferred. The blocking and deblocking proceeds analogously to the two schemes shown hereinabove. The N—H group of the lactam undergoes addition onto the free NCO group to form a urea group. After polymerization of the C═C double bonds the lactam ring may be opened. This formally reforms an acyl cation and a negatively charged N atom. Alcohols or amines may undergo addition onto the acyl cation and transfer the surplus proton to the negatively charged N atom. Here too, the blocking agent remains covalently bonded in the polymer molecule.

Preference is given to the case where the blocking agent is an organic isocyanate. The NCO group to be blocked can then react with the NCO group of the blocking agent to form a uretdione. The retroreaction during step IV) of the process results in reformation of the NCO groups which react with the available chain extenders. It is particularly preferable when the blocking agent and the compound having the NCO group to be blocked are identical. Blocking then comprises a dimerization of the relevant compound. This and the reaction with polyol and polyamine are shown by way of example in the scheme which follows.

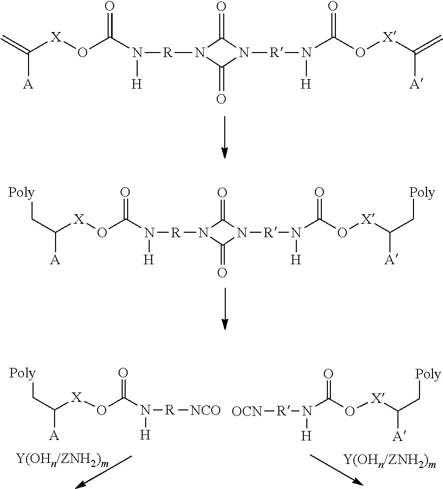

A and A′ here represent any desired radical, preferably hydrogen or alkyl. The groups X and X′ join the alkenyl portion of the molecules with the remainder of the molecule and are in particular carbonyl groups. The groups R and R′ represent any desired further radicals. For example monomeric starting molecules for the above scheme may be understood to mean addition products of one molecule of hydroxyalkyl (meth)acrylate such as 2-hydroxyalkyl methacrylate (HEMA) onto a diisocyanate or a difunctional NCO-terminated prepolymer to form a urethane group. In contrast to the blocking agents more particularly elucidated hereinabove the blocking of the NCO groups by other NCO groups is effected by dimerization, i.e. by formation of a four-membered uretdione ring. After free-radical polymerization of the C═C double bonds the dimer with the NCO groups blocked on alternating sides is incorporated into the same or two different polymer chains “poly”. Deblocking results in opening of the uretdione ring to reform two NCO groups. These may then be reacted with alcohols or amines. Alcohols Y(OH)ₙ or amines Z(NH₂)ₘ (secondary amines are of course also possible) where n≥2 and m≥2 undergo addition onto the NCO groups to form urethane or urea groups.

In a further preferred embodiment the compounds having at least two Zerewitinoff-active H atoms in the curable component are selected from the group consisting of polyamines, polyols or a combination thereof. These may be for example low molecular weight diols (for example 1,2-ethanediol, 1,3- or 1,2-propanediol, 1,4-butanediol), triols (for example glycerol, trimethylolpropane) and tetraols (for example pentaerythritol), short-chain polyamines, but also higher molecular weight polyhydroxyl compounds such as polyether polyols, polyester polyols, polycarbonate polyols, polysiloxane polyols, polyamines and polyether polyamines and polybutadiene polyols.

In a further preferred embodiment the curable component comprises a curable compound which comprises NCO groups blocked with the blocking agent and olefinic C═C double bonds.

In a further preferred embodiment the olefinic double bonds are present in the curable compound at least partially in the form of (meth)acrylate groups.

The curable compound is preferably a compound obtainable from the dimerization of a diisocyanate to afford an NCO-terminated uretdione followed by reaction of the NCO groups with a hydroxyalkyl (meth)acrylate.

Suitable diisocyanates for producing the NCO-terminated uretdiones are for example those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates.

It is further possible in accordance with the invention to also employ aliphatic and/or aromatic isocyanate end group-bearing prepolymers, for example aliphatic or aromatic isocyanate end group-bearing polyether, polyester, polyacrylate, polyepoxide or polycarbonate prepolymers as reactants for the uretdione formation.

Suitable hydroxyalkyl (meth)acrylates are inter alia alkoxyalkyl (meth)acrylates having 2 to 12 carbon atoms in the hydroxyalkyl radical. Preference is given to 2-hydroxyethyl acrylate, the isomer mixture formed during addition of propylene oxide onto acrylic acid, or 4-hydroxybutyl acrylate.

The reaction between the hydroxyalkyl (meth)acrylate and the NCO-terminated uretdione may be catalyzed by the customary urethanization catalysts such as DBTL. The obtained curable compound may have a number-average molecular weight Mₙ of ≥200 g/mol to ≤5000 g/mol. This molecular weight is preferably ≥300 g/mol to ≤4000 g/mol, more preferably ≥400 g/mol to ≤3000 g/mol.

Particular preference is given to a curable compound obtained from the reaction of an NCO-terminated uretdione with hydroxyethyl (meth)acrylate, wherein the NCO-terminated uretdione was obtained from the dimerization of 1,6-hexamethylene diisocyanate, 1,5-pentamethylene diisocyanate or IPDI. This curable compound has a number-average molecular weight Mₙ of ≥400 g/mol to ≤3000 g/mol.

In a further preferred embodiment the free-radically crosslinkable resin further comprises a free-radical starter, optionally also a catalyst and/or an inhibitor. To prevent an undesired increase in the viscosity of the free-radically crosslinkable resin the free-radical starter may be added to the resin only immediately before commencement of the process according to the invention.

Contemplated free-radical starters include thermal and/or photochemical free-radical starters (photoinitiators). It is also possible for thermal and photochemical free-radical starters to be employed simultaneously. Suitable thermal free-radical starters are for example azobisisobutyronitrile (AIBN), dibenzoylperoxide (DBPO), di-tert-butyl peroxide and/or inorganic peroxides such as peroxodisulfates.

Photoinitiators are in principle distinguished into two types, the unimolecular type (I) and the bimolecular type (II). Suitable type (I) systems are aromatic ketone compounds, for example benzophenones in combination with tertiary amines, alkylbenzophenones, 4,4′-bis(dimethylamino)benzophenone (Michler's ketone), anthrone and halogenated benzophenones or mixtures of the recited types. Also suitable are type (II) initiators such as benzoin and derivatives thereof benzil ketals, acylphosphine oxides, 2,4,6-trimethylbenzoyldiphenylphosphine oxide, bisacylphosphine oxides, phenylglyoxylic esters, camphorquinone, α-aminoalkylphenones, α,α-dialkoxyacetophenones and α-hydroxyalkylphenones. Specific examples are Irgacur®500 (a mixture of benzophenone and 1-hydroxycyclohexyl phenyl ketone, from Ciba, Lampertheim, DE), Irgacure®819 DW (phenylbis(2,4,6-trimethylbenzoyl)phosphine oxide, from Ciba, Lampertheim, DE) or Esacure® KIP EM (oligo-[2-hydroxy-2-methyl-1-[4-(1-methylvinyl)phenyl]propanones], from Lamberti, Aldizzate, Italy) and bis(4-methoxybenzoyl)diethylgermanium. Mixtures of these compounds may also be employed.

In a further preferred embodiment the free-radical starter is selected from the group: α-hydroxyphenylketone, benzyldimethylketal, bis(4-methoxybenzoyl)diethylgermanium and/or 2,4,6-trimethylbenzoyldiphenylphosphine oxide.

In a further preferred embodiment the molar ratio of free NCO groups to Zerewitinoff-active H atoms in the resin is ≤0.05 (preferably ≤0.01, more preferably ≤0.005). The molar ratio of NCO groups to Zerewitinoff-active H atoms is also known as the NCO index or coefficient. Suitable carriers of Zerewitinoff-active H atoms include in particular compounds having O—H, N—H or S—H bonds. Alternatively or in addition, this condition may be expressed by specifying that the resin contains compounds comprising free NCO groups in an amount of ≤20 weight % (preferably ≤10 weight %, more preferably ≤5 weight %) based on the mass of the resin.

In a further preferred embodiment the curable component has a number-average molecular weight M. of ≥200 g/mol to ≤5000 g/mol. This molecular weight is preferably ≥300 g/mol to ≤4000 g/mol, more preferably ≥400 g/mol to ≤3000 g/mol.

In a further preferred embodiment in step IV) the treating of the precursor obtained after step III) under conditions sufficient for at least partially deblocking NCO groups present in the free-radically crosslinked resin of the obtained precursor and reacting the thus obtained functional groups with compounds having at least two Zerewitinoff-active H atoms comprises a heating of the body to a temperature of ≥60° C. This temperature is preferably ≥80° C. to ≤250° C., more preferably ≥90° C. to ≤190° C. The chosen temperature or the chosen temperature range in step IV) may be maintained for example for ≥5 minutes to ≤48 hours, preferably ≥15 minutes to ≤24 hours and more preferably ≥1 hour to ≤12 hours.

In a further preferred embodiment the surface of the precursor obtained after step III) and/or of the object obtained after step IV) is contacted with a compound comprising Zerewitinoff-active H atoms, wherein water occurring as natural atmospheric humidity in the atmosphere surrounding the precursor and/or the object is excluded. In a reaction of still available blocked or deblocked NCO groups with these compounds a functionalization of the surfaces can be achieved. The compound comprising Zerewitinoff-active H atoms may be contacted with the surface of the precursor by immersion, spray application or spreading, for example. A further possibility is contacting via the gas phase, for example by means of ammonia or water vapor. A catalyst may optionally accelerate the reaction.

Examples of compounds suitable as a functionalization reagent are alcohols, amines, acids and derivatives thereof, epoxides and in particular polyols, for example sugars, polyacrylate polyols, polyester polyols, polyether polyols, polyvinyl alcohols, polycarbonate polyols, polyether carbonate polyols and polyester carbonate polyols. Further examples are polyacrylic acid, polyamides, polysiloxanes, polyacrylamides, polyvinylpyrrolidones, polyvinyl butyrate, polyketones, polyether ketones, polyacetals and polyamines. Amines may also be used for specific formation of ureas.

It is preferable to employ a long-chain alkyl alcohol, a long-chain (secondary) alkyl amine, a fatty acid, an epoxidized fatty acid ester, a (per)fluorinated long-chain alcohol or mixtures thereof. “Long-chain” is to be understood here as meaning from 6 carbon atoms, preferably from 8 carbon atoms, more preferably from 10 carbon atoms in the longest chain of the compound. The production of modified polyisocyanates is known in principle and described in EP-A 0 206 059 and EP-A 0 540 985 for example. It is effected preferably at temperatures of 40° C. to 180° C.

In a further preferred embodiment the process has the following additional features:
the carrier is arranged inside a container and is vertically lowerable in the direction of the gravitational force,
the container contains provides the free-radically crosslinkable resin,
before each step II) the carrier is lowered by a predetermined distance so that above the uppermost ply of the construction material viewed in the vertical direction a layer of the free-radically crosslinkable resin is formed and
in step II) an energy beam exposes and/or irradiates the selected region of the layer of the free-radically crosslinkable resin corresponding to the respectively selected cross section of the object.

Accordingly, this embodiment covers the additive manufacturing process of stereolithography (SLA). The carrier may for example be lowered by a predetermined distance of ≥1 μm to ≤500 μm in each case.

In a further preferred embodiment the process has the following additional features:
the carrier is arranged inside a container and is vertically raisable counter to the direction of the gravitational force,
the container provides the free-radically crosslinkable resin,
before each step 11) the carrier is raised by a predetermined distance so that below the lowermost ply of the construction material viewed in the vertical direction a layer of the free-radically crosslinkable resin is formed and
in step II) a plurality of energy beams simultaneously exposes and/or irradiates the selected region of the layer of the free-radically crosslinkable resin corresponding to the respectively selected cross section of the object.

Accordingly, this embodiment covers the additive manufacturing process of DLP technology when the plurality of energy beams generate the image to be provided by exposure and/or irradiation via an array of individually controllable micromirrors. The carrier may for example be raised by a predetermined distance of ≥1 μm to ≤500 μm in each case.

In a further preferred embodiment process step I) comprises applying atop a substrate the free-radically crosslinkable resin corresponding to the first selected cross section of the object and step II) comprises applying atop a previously applied ply of the construction material the free-radically crosslinkable resin corresponding to the further selected cross section of the object. This is followed by introduction of energy to at least the free-radically crosslinkable resin.

Accordingly, this embodiment covers the additive manufacturing process of the inkjet method: the crosslinkable resin (optionally separately from catalysts) is applied selectively via one or more printing heads and the subsequent curing by irradiation and/or exposure may be nonselective, for example via a UV lamp. The one or more printing heads for application of the crosslinkable construction material may be a (modified) printing head for inkjet printing processes. The carrier may be configured to be movable away from the printing head or the printing head may be configured to be movable away from the carrier. The increments of the spacing movements between the carrier and the printing head may be in a range from ≥1 μm to ≤2000 μm for example.

The invention also relates to the use of a free-radically crosslinkable resin having a viscosity (23° C., DIN EN ISO 2884-1) of ≥5 mPas to ≤100 000 mPas in an additive manufacturing process, wherein the free-radically crosslinkable resin comprises a curable component comprising NCO groups blocked with a blocking agent, compounds having at least two Zerewitinoff-active H atoms and olefinic C═C double bonds and wherein the blocking agent is an isocyanate or the blocking agent is selected such that deblocking of the NCO group is not followed by liberation of the blocking agent as a free molecule or as a part of other molecules or moieties.

In a preferred embodiment of the use the resin further comprises a free-radical starter and/or an isocyanate trimerization catalyst. It is preferable when the free-radical starter is selected from the group: α-hydroxyphenylketone, benzyldimethylketal und/or 2,4,6-trimethylbenzoyldiphenylphosphine oxide

and/or
the isocyanurate trimerization catalyst is selected from: potassium acetate, potassium acetate in combination with a crown ether, potassium acetate in combination with a polyethylene glycol, potassium acetate in combination with a polypropylene glycol, tin octoate, trioctyl phosphine and/or tributyltin oxide.

In terms of the curable compound the same considerations and preferred embodiments as intimated previously with regard to the process according to the invention apply for the use according to the invention. To avoid unnecessary repetition they are not recited again. It is merely noted that in a further preferred embodiment the olefinic double bonds are present at least partially in the form of (meth)acrylate groups in the curable compound and that in a further preferred embodiment the curable compound is obtainable from the reaction of an NCO-terminated polyisocyanate, preferably polyisocyanurate, with a molar deficiency, based on the free NCO groups, of a hydroxyalkyl (meth)acrylate.

In a further preferred embodiment of the use the additive manufacturing process comprises the exposure and/or irradiation of a previously selected region or applied region of the free-radically crosslinkable resin. The additive manufacturing process may be a stereolithography process or a DLP (digital light processing) process for example. It may likewise be an inkjet process. “Exposure” is to be understood in the present context as meaning introduction of light in the range between near-IR and near-UV light (wavelengths of 1400 nm to 315 nm). The remaining shorter wavelength ranges are covered by the term “irradiation”, for example far UV light, x-ray radiation, gamma radiation and also electron radiation.

The invention further provides a polymer obtainable by the crosslinking of a free-radically crosslinkable resin having a viscosity (23° C., DIN EN ISO 2884-1) of ≥5 mPas to ≤100 000 mPas, wherein the free-radically crosslinkable resin comprises a curable component comprising NCO groups blocked with a blocking agent, compounds having at least two Zerewitinoff-active H atoms and olefinic C═C double bonds and wherein the blocking agent is an isocyanate or the blocking agent is selected such that deblocking of the NCO group is not followed by liberation of the blocking agent as a free molecule or as a part of other molecules or moieties. To avoid unnecessary repetition, in respect of details of the free-radically crosslinkable resin, the curable component, the blocking agents the polyisocyanates and the compounds having at least two Zerewitinoff-active H atoms reference is made to the intimations hereinabove.

### EXAMPLES

### Example 1: Production of a Prepolymer Having Blocked Isocyanates and Acylate Functions

In a glass flask 130.0 g of the linear polypropylene ether polyol Desmophen® 1111BD obtained from Covestro Deutschland AG, Germany were initially charged at room temperature. 0.043 g of dibutyltin laurate obtained from Sigma-Aldrich, Germany was initially added to the polyol and 101.9 g of the hexamethylene diisocyanate-based uretdione Desmodur® XP 2730 obtained from Covestro Deutschland AG, Germany were subsequently added dropwise over a period of about 30 minutes. The reaction mixture was then heated to 80° C. using a temperature-controlled oil bath until the theoretical residual NCO content of 4.71% was achieved. To this end, samples were withdrawn from the reaction vessel at regular intervals and subjected to titrimetric determination according to DIN EN ISO 11909.

After achieving the theoretical residual NCO content, 0.20 g of the inhibitor butylhydroxytoluene obtained from Sigma-Aldrich, Germany was added and the mixture was homogenized for 15 minutes. After cooling to 50° C., 33.8 g of hydroxyethyl methacrylate obtained from Sigma-Aldrich, Germany were then added dropwise and the mixture was subjected to further stirring until a residual NCO content of 0% was achieved. 143.2 g of isobornyl acrylate (IBOA) obtained from Sigma-Aldrich, Germany were then added and the mixture was allowed to cool to room temperature. The prepolymer was filled into metal cans and stored at room temperature until further use.

Without addition of amine as a crosslinking agent the prepolymer according to example 1 was utilized as a comparative example.

In combination with amines as elucidated in the following examples said prepolymer was used as a basis for inventive resins.

### Example 2: Production of a Free-Radically Crosslinkable Resin Comprising 20% IPDA Crosslinker

100.0 g of the prepolymer from example 1 and 3.00 g of the photoinitiator Omnirad® 1173 from IGM Resins were weighed into a plastic beaker with a lid. These input materials were mixed in a Thinky ARE250 planetary mixer at 2000 revolutions per minute at room temperature for about 2 minutes. 2.17 g of the difunctional crosslinker isophoronediamine (IPDA) obtained from Covestro Deutschland AG, Germany were then added and mixed by hand with a spatula. Stoichiometrically, these amounts resulted in a ratio of amine groups to uretdione groups in the mixture of 1:5.

### Example 3: Production of a Free-Radically Crosslinkable Resin Comprising 20% Jeffamine T403 Crosslinker

100.0 g of the prepolymer from example 1 and 3.00 g of the photoinitiator Omnirad® 1173 were weighed into a plastic beaker with a lid and mixed as in example 2. 3.72 g of the trifunctional crosslinker Jeffamine® T403 obtained from Sigma-Aldrich, Germany were then added and mixed by hand with a spatula. Stoichiometrically, these amounts resulted in a ratio of amine groups to uretdione groups in the mixture of 1:5.

### Example 4: Production of a Free-Radically Crosslinkable Resin Comprising 30% Jeffamine T403 Crosslinker

100.0 g of the prepolymer from example 1 and 3.00 g of the photoinitiator Omnirad® 1173 were weighed into a plastic beaker with a lid and mixed as in example 2. 5.59 g of the trifunctional crosslinker Jeffamine® T403 were then added and mixed by hand with a spatula. Stoichiometrically, these amounts resulted in a ratio of amine groups to uretdione groups in the mixture of 3:10.

### Example 5: Curing of a Free-Radically Crosslinkable Resin

A glass sheet was coated with the free-radically curable resins from the examples 1 to 4 using a knife coater having a 400 μm slot. The glass sheet had previously been treated with a 1% solution of soy lecithin in ethyl acetate and dried. The soy lecithin acted as a release agent to allow the cured films to be detached from the substrate again later.

The coated glass substrates were subsequently cured with mercury and gallium radiation sources in a UV curing plant from Superfici at a belt speed of 5 m/min. The lamp output and belt speed result in a radiation intensity of 1300 mJ/cm² being introduced to the coated substrates.

The UV-cured films on the glass substrates were subsequently post-cured in an air atmosphere in a drying oven at 120° C. for 60 minutes. For some films the curing was carried out at 150° C. instead of at 120° C. to investigate the effect of temperature.

After cooling to room temperature the cured films were carefully detached from the glass substrates to prepare test specimens for mechanical and thermal characterization.

### Example 6: Characterization of a Crosslinked Resin

For mechanical characterization the self-supporting, cured films from example 5 were prepared as type S2 tensile test specimens according to DIN EN ISO 527 using a punch. 5 test specimens of each film were investigated according to DIN EN ISO 527. The averaged results for breaking elongation, tensile strength and elastic modulus are summarized in table 1.

For thermal characterization a small sample of about 10 mg of the cured films was investigated using differential scanning calorimetry (DSC) according to DIN EN ISO 11357-1. The glass transition temperatures (T_{G}) determined from DSC are also summarized in table 1 for all films of the examples. Note: Two glass transition temperatures were determined by DSC for the films.

TABLE 1
Mechanical and thermal properties of the free-radically cured resins example number

| | | Post-curing | Elongation | Tensile | Elastic | |
|---|---|---|---|---|---|---|
| | Amine:uretdione | temperature | at break | strength | modulus | T_{G} |
| | ratio | [° C.] | [%] | [MPa] | [MPa] | [° C.] |
| 1 | 0 | room | 94 | 9.6 | 26 | −20/+8 |
| (comparative | | temperature | | | | |
| example) | | | | | | |
| 2 | 1:5 | 120 | 80 | 17.0 | 143 | −14/+23 |
| 2 | 1:5 | 150 | 78 | 16.8 | 141 | −6.5/+31.5 |
| 3 | 1:5 | 120 | 85 | 13.5 | 81.4 | −8/+26 |
| 3 | 1:5 | 150 | 72 | 11.0 | 98.4 | −13/+20 |
| 4 | 3:10 | 120 | 65 | 12.0 | 110 | −6.5/+30 |
| 4 | 3:10 | 150 | 72 | 12.6 | 95.6 | −20/+8 |

Compared to the noninventive example 1, inventive examples 2 to 4 show a markedly elevated tensile strength and modulus while breaking elongation remains at a comparable level.

### Example 7: Investigation of Uretdione Opening by IR Spectroscopy

In order to investigate the opening of the uretdione ring and reaction of the deblocked isocyanate groups with the amine groups during oven curing a film according to example 2 was investigated before and after oven curing by means of IR spectroscopy. Analysis was carried out using an FTIR spectrometer (Tensor II) from Bruker. The specimen film was contacted with the platinum ATR unit. The contacted area of the sample was 2×2 mm. During measurement the IR radiation penetrated 3 to 4 μm into the sample depending on wavenumber. An absorption spectrum was then obtained from the sample. In order to compensate for a nonuniform contacting of the samples of different hardnesses a baseline correction and a normalization in the wavenumber range 2600-3200 (CH2, CH3) was performed on all spectra. The interpolation of the uretdione group was performed in the wavenumber range of 1786-1750 cm⁻¹ (C═O vibration). The integrated areas under the signals of uretdione groups are summarized in table 2:

TABLE 2

| | Uretdione signal area |
|---|---|
| Before oven curing | 26.797 |
| After oven curing | 15.105 |

The reduction in the signal areas corresponding to uretdione can be attributed to a deblocking of the isocyanate groups by ring opening and a crosslinking reaction of the deblocked isocyanate groups with amine.

1.-15. (canceled)

16. A process for producing an object from a precursor, comprising the steps of:
I) depositing a free-radically crosslinked resin atop a carrier to obtain a ply of a construction material joined to the carrier which corresponds to a first selected cross section of the precursor;
II) depositing a free-radically crosslinked resin atop a previously applied ply of the construction material to obtain a further ply of the construction material which corresponds to a further selected cross section of the precursor and which is joined to the previously applied ply;
III) repeating step II) until the precursor is formed;
wherein the depositing of a free-radically crosslinked resin at least in step II) is effected by introducing energy to a selected region of a free-radically crosslinkable resin corresponding to the respectively selected cross section of the object, and
wherein the free-radically crosslinkable resin has a viscosity (23° C., DIN EN ISO 2884-1) of ≥5 mPas to ≤100 000 mPas,
wherein
the free-radically crosslinkable resin comprises a curable component comprising NCO groups blocked with a blocking agent, compounds having at least two Zerewitinoff-active H atoms and olefinic C═C double bonds,
wherein the blocking agent is an isocyanate or the blocking agent is selected such that deblocking of the NCO group is not followed by liberation of the blocking agent as a free molecule or as a part of other molecules or moieties
and in that step III) is followed by a further step IV):
IV) treating the precursor obtained after step III) under conditions sufficient for at least partially deblocking NCO groups present in the free-radically crosslinked resin of the obtained precursor and reacting the thus obtained functional groups with compounds having at least two Zerewitinoff-active H atoms to obtain the object.

17. The process as claimed in claim 16, wherein the blocking agent is selected from the group consisting of organic isocyanates, lactams, glycerol carbonate, a compound of general formula (I): 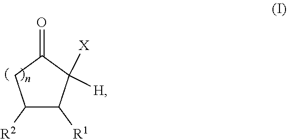
in which X is an electron-withdrawing group, R¹ and R² independently of one another represent the radicals H, C₁-C₂₀-(cyclo)alkyl, C₆-C₂₄-aryl, C₁-C₂₀-(cyclo)alkyl ester or -amide, C₆-C₂₄-aryl ester or amide, mixed aliphatic/aromatic radicals having 1 to 24 carbon atoms which may also be part of a 4 to 8-membered ring and n is an integer from 0 to 5
or a combination of at least two of these.

18. The process as claimed in claim 16, wherein the compounds having at least two Zerewitinoff-active H atoms in the curable component are selected from the group consisting of polyamines, polyols or a combination thereof.

19. The process as claimed in claim 16, wherein the curable component comprises a curable compound which comprises NCO groups blocked with the blocking agent and olefinic C═C double bonds.

20. The process as claimed in claim 16, wherein the free-radically crosslinkable resin further comprises a free-radical starter.

21. The process as claimed in claim 20, wherein the free-radical starter is selected from the group: α-hydroxyphenylketone, benzyldimethylketal, bis(4-methoxybenzoyl)diethylgermanium and/or 2,4,6-trimethylbenzoyldiphenylphosphine oxide.

22. The process as claimed in claim 16, wherein the molar ratio of free NCO groups to Zerewitinoff-active H atoms in the resin is ≤0.05.

23. The process as claimed in claim 16, wherein in step IV) the treating of the precursor obtained after step III) under conditions sufficient for at least partially deblocking NCO groups present in the free-radically crosslinked resin of the obtained precursor and reacting the thus obtained functional groups with compounds having at least two Zerewitinoff-active H atoms comprises a heating of the body to a temperature of ≥60° C.

24. The process as claimed in claim 16, wherein the surface of the precursor obtained after step III) and/or of the object obtained after step IV) is contacted with a compound comprising Zerewitinoff-active H atoms, wherein water occurring as natural atmospheric humidity in the atmosphere surrounding the precursor and/or the object is excluded.

25. The process as claimed in claim 16, wherein:
the carrier is arranged inside a container and is vertically lowerable in the direction of the gravitational force,
the container provides the free-radically crosslinkable resin,
before each step II) the carrier is lowered by a predetermined distance so that above the uppermost ply of the construction material viewed in the vertical direction a layer of the free-radically crosslinkable resin is formed and
in step II) an energy beam exposes and/or irradiates the selected region of the layer of the free-radically crosslinkable resin corresponding to the respectively selected cross section of the object.

26. The process as claimed in claim 16, wherein:
the carrier is arranged inside a container and is vertically raisable counter to the direction of the gravitational force,
the container provides the free-radically crosslinkable resin,
before each step II) the carrier is raised by a predetermined distance so that below the lowermost ply of the construction material viewed in the vertical direction a layer of the free-radically crosslinkable resin is formed and
in step II) a plurality of energy beams simultaneously exposes and/or irradiates the selected region of the layer of the free-radically crosslinkable resin corresponding to the respectively selected cross section of the object.

27. The process as claimed in claim 16, wherein step I) comprises applying atop a substrate the free-radically crosslinkable resin corresponding to the first selected cross section of the object and step II) comprises applying atop a previously applied ply of the construction material the free-radically crosslinkable resin corresponding to the further selected cross section of the object and this is followed by introduction of energy to at least the free-radically crosslinkable resin.

28. A method comprising utilizing a free-radically crosslinkable resin having a viscosity (23° C., DIN EN ISO 2884-1) of ≥5 mPas to ≤100 000 mPas in an additive manufacturing process,
wherein
the free-radically crosslinkable resin comprises a curable component comprising NCO groups blocked with a blocking agent, compounds having at least two Zerewitinoff-active H atoms and olefinic C═C double bonds,
wherein the blocking agent is an isocyanate or the blocking agent is selected such that deblocking of the NCO group is not followed by liberation of the blocking agent as a free molecule or as a part of other molecules or moieties.

29. The method as claimed in claim 28, wherein the additive manufacturing process comprises the exposure and/or irradiation of a previously selected region or applied region of the free-radically crosslinkable resin.

30. A polymer obtainable by the crosslinking of a free-radically crosslinkable resin having a viscosity (23° C., DIN EN ISO 2884-1) of ≥5 mPas to ≤100 000 mPas,
wherein
the free-radically crosslinkable resin comprises a curable component comprising NCO groups blocked with a blocking agent, compounds having at least two Zerewitinoff-active H atoms and olefinic C═C double bonds,
wherein the blocking agent is an isocyanate or the blocking agent is selected such that deblocking of the NCO group is not followed by liberation of the blocking agent as a free molecule or as a part of other molecules or moieties.
